(19) United States
(12) Patent Application Publication
(10) Pub. No.: US 2020/0204271 A1
(43) Pub. Date: Jun. 25, 2020

(54) ACOUSTIC TRANSMISSION DEVICE

(71) Applicant: Commissariat a l'Energie Atomique et aux Energies Alternatives, Paris (FR)

(72) Inventors: François FRASSATI, Grenoble (FR); Vincent JOSSELIN, Grenoble (FR)

(21) Appl. No.: 16/719,763

(22) Filed: Dec. 18, 2019

(30) Foreign Application Priority Data
Dec. 19, 2018 (FR) 1873338

(51) Int. Cl. H04B 11/00; H04B 17/10

(52) U.S. Cl. CPC H04B 11/00; H04B 17/101

(57) ABSTRACT

The invention concerns: a method including a step of defining an acoustic transmission frequency according to the admittance of an acoustic generator; an acoustic transmitter including the acoustic generator, configured to define said acoustic transmission frequency according to the admittance of the generator; and an acoustic receiver configured to receive an acoustic transmission signal having said transmission frequency.

### FIELD

The present disclosure generally concerns electro-acoustic devices, and in particular an acoustic transmission system.

### BACKGROUND

In an acoustic transmission system, data and/or power are acoustically transmitted between a transmitter and a receiver. The data and/or the power are thus transmitted wireless. Such a system is for example used when it is difficult or not desired to perform the transmission over a wire or by electromagnetic waves, for example, radio frequency.

### SUMMARY

An embodiment overcomes all or part of the disadvantages of known acoustic transmission systems.

An embodiment overcomes all or part of the disadvantages of known acoustic transmitters and/or receivers.

An embodiment overcomes all or part of the disadvantages of known acoustic transmission methods.

An embodiment provides a method comprising steps of:

definition of an acoustic transmission frequency according to the admittance of an acoustic generator;

transmission, by said generator secured on a side of a wall, of an acoustic transmission signal having said frequency;

reception of the acoustic transmission signal by an acoustic receiver secured on another side of the wall.

An embodiment provides an acoustic transmitter comprising an acoustic generator intended to be secured on one side of a wall, configured to define a frequency of an acoustic transmission signal according to the admittance of the generator, the acoustic transmission signal being intended to be received by an acoustic receiver secured on another side of the wall.

An embodiment provides an acoustic receiver intended to be secured on one side of a wall, configured to receive an acoustic transmission signal having a frequency defined according to the admittance of an acoustic generator, the acoustic transmission signal being transmitted by a transmitter secured on another side of the wall and comprising the generator.

According to an embodiment, one or said acoustic receiver is powered by the received acoustic transmission signal.

According to an embodiment, one or said acoustic receiver is powered only when an acoustic intensity received by the receiver is greater than a threshold.

According to an embodiment, said admittance is the admittance between two terminals of application, to the generator, of a first excitation signal.

According to an embodiment, when the first signal is applied, said intensity is lower than said threshold.

According to an embodiment, after the definition of said frequency, a second excitation signal having a peak voltage greater than a peak voltage of the first signal is applied to the generator.

According to an embodiment, said frequency is adjusted when the second excitation signal is applied.

According to an embodiment, said admittance is measured by an admittance measurement circuit.

According to an embodiment, an acoustic communication frequency band is centered on said frequency.

According to an embodiment, said frequency is defined so that the phase of said admittance is substantially extremal for said frequency.

According to an embodiment, two values of a current and of a voltage applied to the generator are obtained by IQ demodulation, and then are divided by one another.

An embodiment provides a system comprising a transmitter and a receiver such as defined hereabove.

According to an embodiment, the system further comprises said wall, the generator and the receiver being secured to the wall on either side of the wall.

The foregoing and other features and advantages will be discussed in detail in the following non-limiting description of specific embodiments in connection with the accompanying drawings.

### BRIEF DESCRIPTION OF THE DRAWINGS

FIG. 1 schematically shows an acoustic transmission system of the type to which the described embodiments apply;

FIG. 2 schematically shows an embodiment of an acoustic transmitter;

FIG. 3 schematically shows an embodiment of an acoustic receiver;

FIG. 4 illustrates in the form of blocks an embodiment of a method implemented by the transmitter of FIG. 2 and the receiver of FIG. 3;

FIG. 5 illustrates examples of shapes of an acoustic intensity of the corresponding modulus of an admittance and of the corresponding phase of this admittance, according to frequency;

FIG. 6 schematically shows an embodiment of an acoustic transmitter;

FIG. 7 schematically shows an embodiment of a demodulator of the transmitter of FIG. 6; and

FIG. 8 schematically shows examples of elements of the demodulator of FIG. 7.

### DETAILED DESCRIPTION OF THE PRESENT EMBODIMENTS

The same elements have been designated with the same reference numerals in the different drawings. In particular, the structural and/or functional elements common to the different embodiments may be designated with the same reference numerals and may have identical structural, dimensional, and material properties.

For clarity, only those steps and elements which are useful to the understanding of the described embodiments have been shown and are detailed. In particular, circuits of generation of an AC signal for controlling the frequency of this signal, as well as circuits of control and of reception of values delivered by sensors, are not described in detail, the described embodiments being compatible with such usual circuits.

Throughout the present disclosure, the term “connected” is used to designate a direct electrical connection between circuit elements with no intermediate elements other than conductors, whereas the term “coupled” is used to designate an electrical connection between circuit elements that may be direct, or may be via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., unless otherwise specified, it is referred to the orientation of the drawings.

The terms “about”, “approximately”, “substantially”, and “in the order of” are used herein to designate a tolerance of plus or minus 10%, preferably of plus or minus 5%, of the value in question.

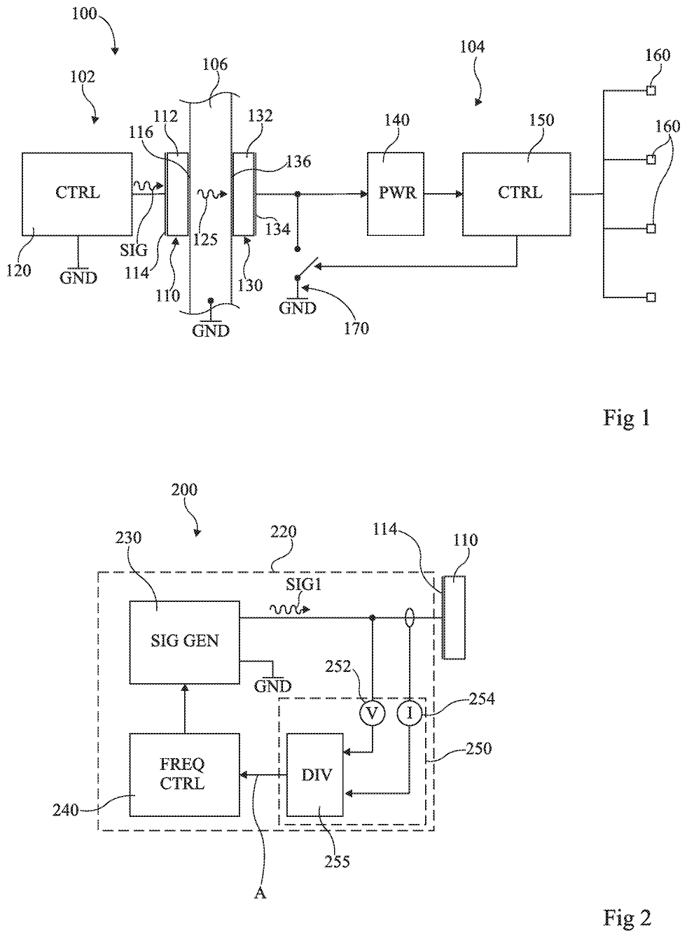

FIG. 1 schematically shows an acoustic communication system of the type to which the described embodiments apply.

System 100 comprises an acoustic transmitter 102 and an acoustic receiver 104.

Transmitter 102 and receiver 104 are separated by a wall 106.

Transmitter 102 comprises an acoustic generator 110 secured to wall 106. Acoustic generator 110 preferably comprises a piezoelectric transducer 112. Piezoelectric transducer 112 is for example arranged between an electrode 114 and a surface of wall 106. As an example, wall 106 is conductive and defines a ground GND. Wall 106 thus defines another electrode of piezoelectric transducer 112. Wall 106 and electrode 114 thus form terminals of acoustic generator 110. Piezoelectric transducer 112 is for example secured to the wall by glue 116. Acoustic generator 110 is coupled to a control circuit 120 (CTRL). As a variation, transducer 112 is arranged between electrode 114 and another electrode located between the transducer and the wall. The wall is then possibly non-conductive or may comprise a non-conductive layer against generator 110.

In operation, control circuit 120 applies to generator 110 an AC signal SIG, for example, referenced to ground GND. The application of signal SIG to generator 110 causes an acoustic transmission signal (acoustic waves 125), for example, ultrasound waves. Signal SIG thus corresponds to a generator excitation signal. The acoustic transmission frequency is that of signal SIG.

Receiver 104 comprises an acoustic sensor 130 secured to wall 106. Acoustic sensor 130 preferably comprises a piezoelectric transducer 132. Piezoelectric transducer 132 is preferably of the same type as transducer 112. Transducer 132 is located between an electrode 134 and wall 106, which define the terminals of acoustic sensor 130. Piezoelectric transducer 132 is secured to a surface of wall 106 opposite to generator 110, preferably facing generator 110. The securing is for example achieved by means of glue 136. For example, transducers 112 and 132 are arranged symmetrically with respect to the wall. Receiver 104 further comprises a power unit 140 (PWR) coupled to a circuit 150 (CTRL).

In operation, acoustic waves 125 are received by sensor 130. Sensor 130 converts the received acoustic waves into electric power, and delivers an AC voltage, for example, referenced to ground GND. Unit 140 stores this power and uses it to power control circuit 150.

In system 100, receiver 104 is thus powered through wall 106. Such a powering is performed without perforating the wall. A system of this type may be used in applications where the receiver is located in a confined or inaccessible environment. For example, wall 106 may be that of a nuclear containment enclosure, of a plane, of a ship, or also of a pipe. In the case of a pipe, generator 110 is for example secured to the pipe by a collar and acoustically coupled to the pipe by an acoustic transmission gel. Wall 106 has a thickness preferably greater than approximately 5 mm, for example, in the order of 50 mm.

Circuit 150 for example forms a circuit of control and/or power supply of sensors 160 and of reception of value supplied by the sensors. Sensors 160 for example sense physical values such as pressure, temperature, salinity, speed, radiation level values, or also, for example, corrosion current or voltage values.

Typically, system 100 further enables to transmit from circuit 150 to circuit 120 data such as the sensed physical values. To achieve this, receiver 104 further comprises a switch 170, for example, a transistor, coupling together the terminals of sensor 130. In operation, in transmitter 102, the impedance of generator 110 submitted to signal SIG depends on the on or off state of the switch 170 of receiver 104. Thus, to transmit a data bit to circuit 120, circuit 150 turns switch 170 off and on in a way depending on the value of the bit to be transmitted. Circuit 120 deduces the value of the bit from the impedance of generator 110. Such a transmission technique, called load modulation, enables to limit the power consumption by the receiver. In particular, switch 110 may be in series with an impedance, not shown. This impedance decreases the power consumption by the receiver, and thus decreases the difference between impedances of generator 110 for the on and off positions of switch 170. The impedance can thus be selected to optimize the tradeoff between the transmission quality and the power consumption.

Data may also be transmitted from circuit 120 of transmitter 102 to circuit 150 of receiver 104. For this purpose, for example, circuit 120 modulates acoustic transmission frequency 125. Circuit 150 demodulates the received acoustic signal to collect the data. The described embodiments are compatible with known acoustic communication modes.

FIG. 2 schematically shows an embodiment of an acoustic transmitter 200. More particularly, acoustic transmitter 200 comprises an acoustic generator 110, identical or similar to that of the transmitter 102 of the system of FIG. 1. The generator is coupled to a circuit 220 replacing the circuit 120 of transmitter 102 of the system of FIG. 1.

Circuit 220 comprises a signal generation circuit 230 (SIG GEN). Circuit 230 is coupled, preferably connected, to terminal 114 of acoustic generator 110 and to the ground intended to form another terminal of acoustic generator 110. As a variation, circuit 230 is coupled, preferably connected, to two terminals of acoustic generator 110. Circuit 220 further comprises a control circuit 240 (FRQ CTRL) which sets the frequency of the signal generated by circuit 230.

In the present embodiment, circuit 220 comprises a circuit 250 for measuring admittance A of generator 110. Admittance A corresponds, when generator 110 is submitted to a signal SIG1 generated by generator 110, to the ratio of the current and voltage values across the generator. Admittance A is delivered to circuit 240. Circuit 240 uses admittance A of generator 110 to define the frequency of signal SIG1.

Preferably, circuit 250 comprises a voltage sensor 252 (V). Sensor 252 measures the voltage applied by circuit 230 across acoustic generator 110, for example, the potential, referenced to ground, of terminal 114. Preferably, circuit 250 comprises a current sensor 254 (I). Sensor 254 measures the current applied to acoustic generator 110 by circuit 230. Preferably, circuit 250 further comprises a circuit 255 (DIV) which delivers admittance A. To achieve this, circuit 255 determines complex values, each comprising a phase and an amplitude, representative of the signals respectively supplied by sensors 252 and 254. Circuit 250 divides by one another the complex values to obtain the admittance.

Circuit 250 may be any circuit capable of supplying a value representative of the admittance of generator 110. The described embodiments are compatible with known admittance measurement circuits.

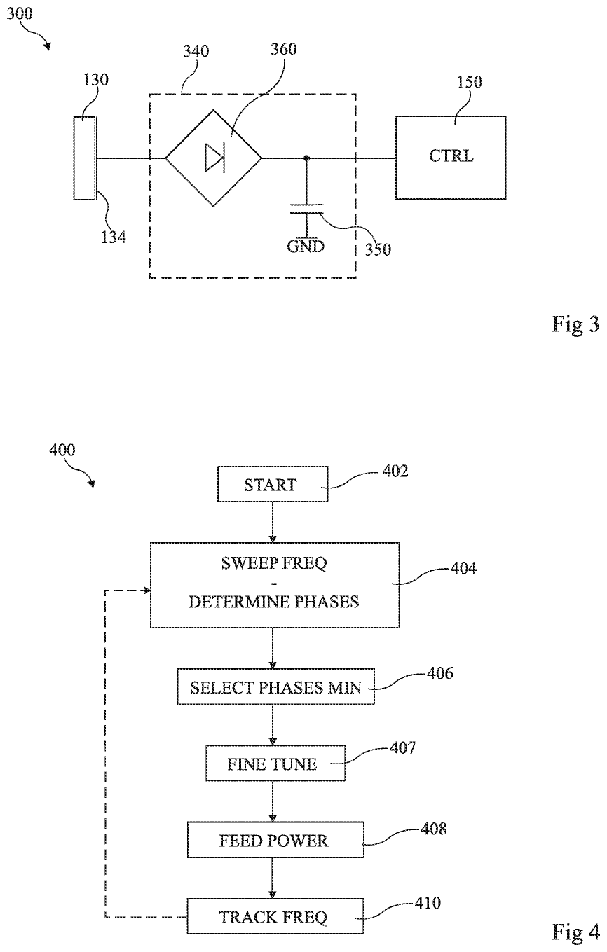

FIG. 3 schematically shows an embodiment of an acoustic receiver 300, intended to receive acoustic transmission signals originating from transmitter 200 of FIG. 2.

Receiver 300 comprises an ultrasound sensor 130 and a control circuit 150, identical or similar to those of FIG. 1. In receiver 300, the function of the power supply unit 140 of FIG. 1 is fulfilled with a power supply unit 340. Receiver 300 may further comprise other elements such as sensors 160 or switch 170 of the receiver of FIG. 1.

Power supply unit 340 comprises a power storage element, for example, a capacitive element 350. Capacitive element 350 preferably couples the input of circuit 150 to a node of application of a reference potential, for example, ground GND. Power supply unit 340 further comprises a circuit 360 of charge of capacitive element 350 from the electric power supplied by sensor 130.

Preferably, circuit 360 charges capacitive element 350 only when the acoustic intensity received by sensor 130 is greater than a threshold TH. Threshold TH may be constant or vary according to the frequency of the received acoustic waves.

According to an embodiment, the acoustic intensity threshold TH is selected so that when the voltage applied to circuit 360 reaches a corresponding threshold, the voltage of capacitive element 350 (initially discharged) reaches a given percentage of the peak value of the voltage applied within a given time. For example, threshold TH may be set so that by applying the corresponding AC voltage to circuit 360, the voltage of the capacitive element reaches 63% of the peak value within more than approximately 10 seconds, for example, within more than 1 minute, preferably within more than 10 minutes.

According to an embodiment, preferably combined with the previous embodiment, threshold TH is selected so that when the received acoustic intensity is equal to threshold TH, the input resistance or impedance of circuit 360 is greater than approximately 1 kΩ, for example, more than 10 kΩ, preferably more than 100 kΩ, for example, 100 kΩ.

For example, charge circuit 360 comprises a diode bridge having its input coupled, preferably connected, to terminal 134 of sensor 130 and its output coupled, preferably connected, to capacitive element 350. The value of threshold TH is the received acoustic intensity for which the threshold voltage of the diodes of the diode bridge corresponds to the voltage generated by sensor 130.

FIG. 4 illustrates in the form of blocks an embodiment of a method 400 implemented by the transmitter 200 of FIG. 2 and the receiver 300 of FIG. 3. Preferably, the circuit 240 of transmitter 200 and the circuit 150 of receiver 300 each comprise a data processing unit such as a microprocessor and a memory containing a program. The execution of the programs respectively by the microprocessor of the transmitter and, when the receiver is powered, the microprocessor of the receiver, implements method 400.

At an initial step 402 (START), capacitive element 350 is discharged. Circuit 150 of the receiver is not powered.

At a step 404 (SWEEP FREQ—DETERMINE PHASES), transmitter 200 transmits acoustic waves. Preferably, the intensity of the acoustic waves is sufficiently low for the intensity received by sensor 130 to be lower than threshold TH. For this purpose, the peak voltage of signal SIG1 applied by circuit 230 of transmitter 200 to acoustic generator 110 is preferably smaller than approximately 0.5 V, for example, equal to approximately 0.2 V. Thus, receiver 300 is not electrically powered during step 404.

At step 404, the frequency of the acoustic transmissions sweeps a frequency range. For example, the swept frequency range is between 40 kHz and 5 MHz, preferably between 100 kHz and 2 MHz. Preferably, the sweeping is performed in successive steps. The step is for example in the range from approximately 1 kHz to approximately 20 kHz, for example, 10 kHz.

For each applied frequency, the transmitter determines the admittance of generator 110, or at least a value representative of the phase or of the amplitude of this admittance. Preferably, for each frequency, the transmitter measures the phase of the admittance of generator 110 or a value representative of this phase.

Preferably, at a step 406 (SELECT PHASES MIN), transmitter 200 selects one or a plurality of frequencies in the swept range. Preferably, the selected frequencies are frequencies for which the phase of the admittance of the generator has a substantially extremal value. Preferably, the selected frequencies are, among the frequencies applied during the sweeping, frequencies for which the phase of the admittance is substantially minimum. As a variation, the selected frequencies are frequencies for which the amplitude and/or the phase of the admittance exhibit extremum values.

Preferably, at a step 407 (FINE TUNE), a finer sweeping than that of step 404 is performed around each frequency selected at step 406. Preferably, the sweeping is performed in successive steps, preferably in the range from approximately 20 Hz to approximately 200 Hz, for example, 100 Hz. An acoustic transmission frequency f0 is then selected. Preferably, the selected frequency f0 is that for which the phase of the admittance has a substantially minimum value and/or the phase remains close to a minimum value over a maximum frequency range.

As a variation, step 407 may be omitted, frequency f0 being directly selected from admittance amplitude and/or phase values determined at step 404, for example, among values for which the amplitude or the phase are extremal.

At a step 408 (FEED POWER) subsequent to steps 404 and 406 of definition of frequency f0, receiver 300 is powered. For this purpose, generator 110 applies a signal SIG2 having a sufficient intensity for the intensity of the acoustic waves received by the sensor 130 of receiver 300 to exceed threshold TH. Preferably, the peak voltage of signal SIG2 applied to generator 110 at step 408 is more than 10 times, for example, more than 50 times, greater than that of the signal SIG1 applied to generator 110 at step 404.

Preferably, at a step 410 (TRACK FREQ), receiver 300 is powered and the transmitter and the receiver communicate with acoustic waves. Preferably, the acoustic communication is performed in a frequency band centered around the frequency f0 defined at steps 404 and 406.

During the communication, receiver 300 preferably informs transmitter 200 of the received acoustic intensity. Transmitter 200 then adjusts frequency f0 to optimize the acoustic communication. Preferably, the adjusted frequency corresponds to a maximum value of the intensity received by receiver 300. For this purpose, for example, the central frequency of the frequency band, initially at value f0, is decreased or increased in successive steps to obtain the maximum received intensity. The steps used for the adjustment are preferably smaller than approximately 50 Hz, for example, equal to 20 Hz. As a variation, any known acoustic communication frequency adjustment method may be used.

In a variation, shown in dotted lines, the method, after step 410, returns to step 404 to define a new frequency f0.

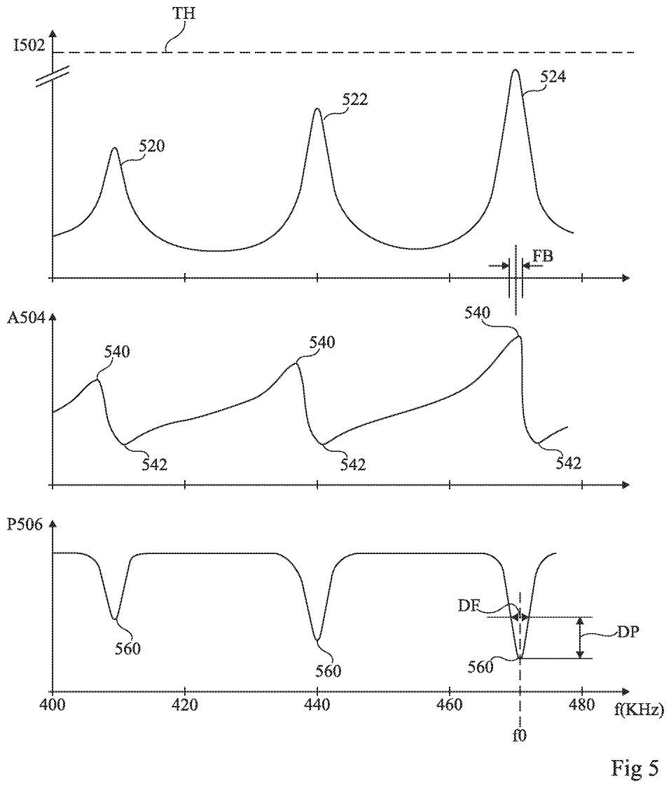

FIG. 5 shows, according to frequency, examples of shapes of an acoustic intensity 1502, of the amplitude A504, or modulus, of the corresponding admittance, and of the phase P506, or argument, or this admittance.

The acoustic intensity 1502 illustrated herein is received by sensor 130 when the signal SIG1 applied to generator 110 has a constant peak voltage, or amplitude, according to frequency. Although the applied signal is constant, the received acoustic intensity is not constant. This is due to various phenomena of acoustic resonance of the system components, particularly of acoustic generator 110, of wall 106, and of sensor 130. The received acoustic intensity exhibits peaks 520, 522, 524. Typically, the peaks do not have equal heights, peak 524 being here higher than peak 520. Preferably, the peak voltage of signal SIG1 is selected so that the maximum intensity received in the scanned frequency range, here that of peak 524, remains lower than threshold TH.

The inventors have observed that the admittance exhibits variations around the frequencies of the received intensity peaks. In particular, the amplitude of the admittance has a maximum 540 and a minimum 542 for each peak. The phase of the admittance has an extreme value 560 for each peak. When the received intensity remains smaller than threshold TH during the determination of the admittance, the frequency corresponding to the extremum values of the admittance phase is close to that of the received intensity peaks, for example, the difference between the frequency of the extremum values of the phase and that of the intensity peaks is typically smaller than 500 Hz, or even smaller than 100 Hz. Thus, the fact of defining frequency f0 based on the admittance of generator 110 enables to obtain a substantially maximum acoustic intensity transmitted from the transmitter to the receiver. During the receiver power supply step, the charge of the capacitive element is faster than if the frequency used to power the receiver does not correspond to a frequency based on the admittance of the generator. Further, the risk of using a frequency for which the received acoustic intensity would be too low to succeed in powering the receiver is avoided. Further, frequency f0 is defined with no previous powering of the receiver, and in particular without for it to need communicating data such as the received acoustic intensity to the transmitter.

The communication is then established in an acoustic communication frequency band FB. This band preferably has a width smaller than 50 kHz, for example, in the order of 1 kHz. The above-defined central frequency f0 enables, after a possible adjustment, to obtain in this frequency band a maximum intensity of the acoustic communication signal received by the receiver. The power transmission is thus optimized. When the admittance is determined for a received acoustic intensity smaller than threshold TH, the fact for the frequency of the extremum values of the phase to be close to that of the intensity peaks enables to obtain a maximum intensity without requiring adjusting frequency f0, or enables to simplify a possible adjustment of frequency f0.

Around each extremum value of the phase, the phase remains close to its extremum value over a frequency range of width DF. For example, frequency range DF is that where the phase difference between the phase and its extremum value is smaller than a given value DP. As an example, value DP is in the range from 5 to 30 degrees, for example, equal to 10 degrees or to 20 degrees. The inventors have observed that the higher width DF, the wider the corresponding received intensity peak.

As mentioned hereabove, the selected frequency f0 is preferably, among the frequencies corresponding to phase extremum values, that for which width DF is maximum. The transmitted acoustic intensity is thus maximum in a frequency range of maximum width. This enables to optimize the data transmission, particularly the rate of the transmitted data.

Thus, the fact of defining frequency f0 based on the admittance of generator 110 provides an optimal frequency band for the transmission of data and/or of power.

The frequencies of intensity peaks 520, 522, and 524 may vary, typically according to the temperature of the elements forming the communication system, such as generator 110, wall 106, and sensor 130. Variations may also occur, in the case of a maritime application, for example according to the temperature of the sea water. Due to the fact that frequency f0 is based on the generator admittance, an optimum frequency of power supply of the receiver and/or of acoustic communication for any frequency, or position, not anticipated, of the intensity peaks, is obtained.

Although frequency f0 is defined hereabove by an extremum value of the admittance phase, the phase of any value representative of the admittance, for example, that of the impedance of generator 110 (inverse of admittance A) may be used. As a variation, frequency f0 may correspond to an extremum value 540 or 542 of the amplitude of the admittance or of a value representative of the admittance, or also to a maximum of the variation of the amplitude of the admittance or of a value representative of the admittance.

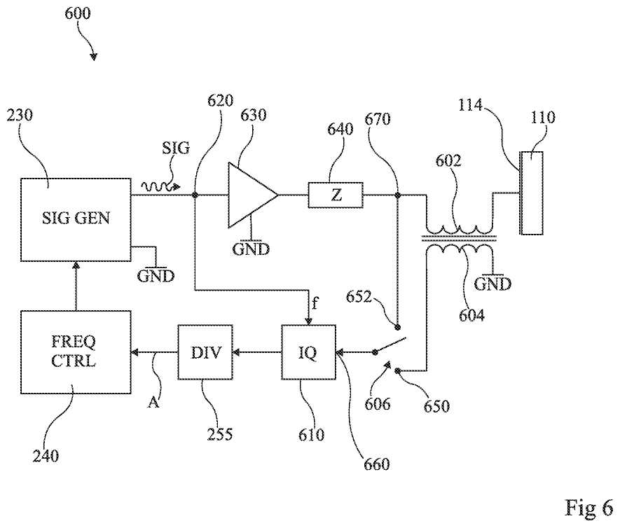

FIG. 6 schematically shows an embodiment of an acoustic transmitter 600. Transmitter 600 comprises elements identical or similar to those of the transmitter of FIG. 2, arranged in the same way. These elements are not described again. As compared with the transmitter of FIG. 2, the functions of sensors 252 and 254 of the transmitter of FIG. 2 are fulfilled, in transmitter 600, by mutually coupled inductances 602 and 604, a selection switch 606, and an IQ (In phase/Quadrature) demodulator 610.

Inductance 602 is located between an output node 620 of circuit 230 and terminal 114 of generator 110. Preferably, transmitter 600 further comprises, in series with inductance 602 between node 620 and terminal 114, an amplifier 630 and an impedance matching circuit 640 (Z). The input of amplifier 630 receives an output signal SIG from circuit 230. Signal SIG successively corresponds to signals SIG1 and SIG2 of the method 400 of FIG. 4. The output of amplifier 630 is coupled, preferably connected, to the input of circuit 640. Circuit 640 preferably comprises passive components such as resistive and/or inductive elements.

Selection switch 606, for example, a multiplexer, has two input nodes 650 and 652. In one position of switch 606, input node 650 is connected to input 660 of IQ demodulator 610. In another position of switch 606, node 652 is connected to input 660 of IQ demodulator 610. Node 652 is coupled, preferably connected, to a terminal of inductance 602, for example, a terminal 670 located between circuit 640 and inductance 602. As a variation, node 652 is directly connected to terminal 114 of generator 110.

IQ demodulator 610 receives frequency f of signal SIG generated by circuit 230. IQ demodulator 610 demodulates at frequency f the signal received on its input and delivers a demodulated value to circuit 255.

When IQ demodulator 610 is connected to node 650, the value supplied by IQ demodulator 610 is representative of the current in generator 110. When IQ demodulator 610 is connected to node 652, the value supplied by IQ demodulator 610 is representative of the voltage across generator 110. In an example, to obtain the generator admittance, switch 606 is successively positioned to select node 650 and then node 652. Circuit 255 stores the received current value, and then divides the stored current value with the received voltage value. In another example, to obtain the admittance of generator 110, switch 606 is successively positioned to select node 652 and then node 650. Circuit 255 stores the voltage value and then divides the received current value with the stored voltage value.

Due to the fact that the voltage and the current applied to generator 110 are not simultaneously measured, a single IQ generator is thus used to measure the admittance of generator 110.

In a variation, switch 606 is omitted. Terminal 670 is then coupled to the input of IQ demodulator 610 and node 652 is replaced with an input node of another IQ demodulator. The IQ demodulators supply divider 255, preferably simultaneously, with the voltage and current values. An advantage of this variation is that it enables to measure the admittance faster than with a single demodulator. In particular, the duration of the frequency sweep may be decreased.

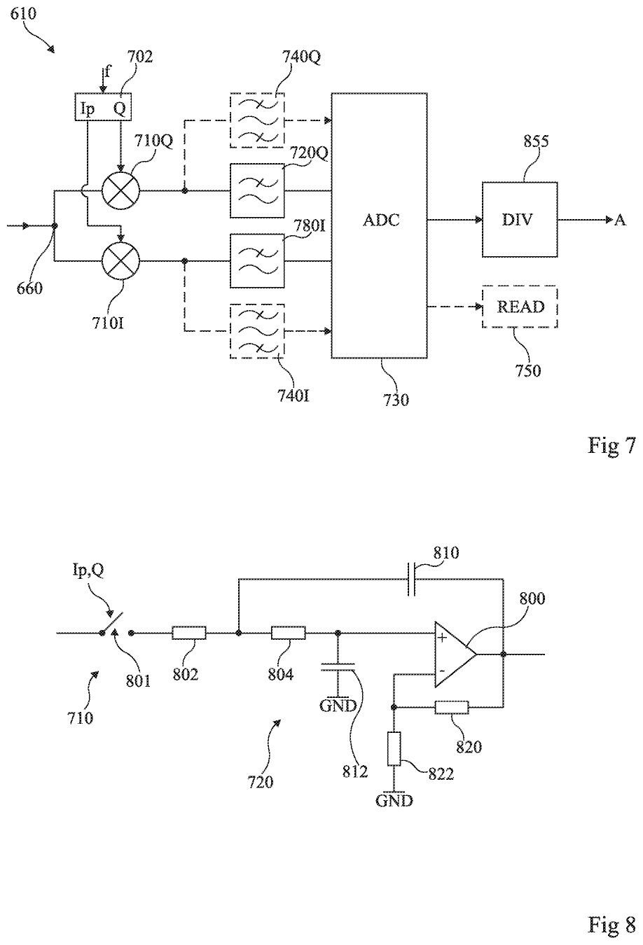

FIG. 7 schematically shows an embodiment of the IQ demodulator 610 of the transmitter of FIG. 6.

IQ demodulator 610 comprises a phase-shift circuit 702. Circuit 702 receives signal SIG at frequency f. Circuit 702 supplies signals at frequency f phase-shifted by 90 degrees with respect to one another. Preferably, these signals are signals in phase Ip and in quadrature Q with the signal received by circuit 702. A mixer 710Q receives signal Q and the signal from switch 606 (FIG. 6, applied to input 660). A low-pass filter 720Q couples the output of mixer 710Q to an input of an analog-to-digital converter 730 (ADC). A mixer 7101 receives signal Ip and the signal applied to input 660. A low-pass filter 7201 couples the output of mixer 7101 to another input of converter 730. Converter 730 delivers the complex current and voltage values.

In a variation, shown in dotted lines, the demodulator further comprises band-pass filters 740Q and 7401 respectively coupling the outputs of mixers 710Q and 7101 to other inputs of converter 730. When a receiver comprising a switch 170 (FIG. 1) transmits an information to the transmitter, the receiver turns switch 170 off and on at the central frequency of filters 740Q and 7401. The output of converter 730 then supplies the data originating from the receiver, for example, to a circuit 750 (READ), which uses the data.

FIG. 8 schematically shows a mixer 710 in series with a low-pass filter 720 of the IQ demodulator of FIG. 7. Mixer 710 may form one and/or the other of mixers 710Q and 7101 of the demodulator of FIG. 7. Low-pass filter 720 may form one and/or the other of low-pass filters 720Q and 7201 of the demodulator of FIG. 7.

Mixer 710 for example comprises a switch 801 controlled by signal Ip or Q from circuit 702 of the demodulator of FIG. 7. Low-pass filter 720 is preferably a circuit of Sallen and Key filter type, that is, comprising:

an amplifier 800 of operational amplifier type having its output corresponding to the output of filter 720;

a series association of two resistors 802 and 804 coupling the input of the filter to the non-inverting input of amplifier 800;

a capacitive element 810 coupling the output of amplifier 800 to the junction point of resistors 802 and 804; and

a capacitive element 812 coupling the non-inverting input of amplifier 800 to ground.

The inverting input of amplifier 800 is directly coupled to the output of the amplifier or, preferably, to the midpoint of a dividing bridge formed of resistors 820 and 822 in series between the output of amplifier 800 and the ground.

The values of resistances 802, 804, 820, and 822 and of capacitances 810 and 812 are selected to obtain a low-pass filter of order 2.

Various embodiments and variations have been described. It will be understood by those skilled in the art that certain features of these various embodiments and variations may be combined, and other variations will occur to those skilled in the art.

Finally, the practical implementation of the described embodiments and variations is within the abilities of those skilled in the art based on the functional indications given hereabove. In particular, the selection of the frequency range used depends on the application.

1. A method comprising steps of:
measurement of the admittance of an acoustic generator;
use of said admittance to define an acoustic transmission frequency;
transmission, by said generator secured on one side of a wall, of an acoustic transmission signal having said frequency; and
reception of the acoustic transmission signal by an acoustic receiver secured on another side of the wall.

2. The method of claim 1, wherein one or said acoustic receiver is powered by the received acoustic transmission signal.

3. The method of claim 1, wherein one or said acoustic receiver is powered only when an acoustic intensity received by the receiver is greater than a threshold.

4. The method of claim 1, wherein said admittance is the admittance between two terminals of application, to the generator, of a first excitation signal.

5. The method of claims 3, wherein, wherein said admittance is the admittance between two terminals of application, to the generator, of a first excitation signal, and when the first signal is applied, said intensity is smaller than said threshold.

6. The method of claim 4, wherein, after the definition of said frequency, a second excitation signal having a peak voltage greater than a peak voltage of the first excitation signal is applied to the generator.

7. The method of claim 6, wherein said frequency is adjusted when the second excitation signal is applied.

8. The method of claim 1, wherein an acoustic communication frequency band is centered on said frequency.

9. The method of claim 1, wherein said frequency is defined so that the phase of said admittance is substantially extremal for said frequency.

10. The method of claim 1, wherein two values of a current and of a voltage applied to the generator are obtained by IQ demodulation and are then divided by one another.

11. An acoustic transmitter comprising an acoustic generator intended to be secured on one side of a wall, configured to define a frequency of an acoustic transmission signal according to the admittance of the generator, the acoustic transmission signal being intended to be received by an acoustic receiver secured on another side of the wall.

12. The transmitter of claim 11, wherein one acoustic receiver secured on another side of the wall is powered only when an acoustic intensity received by the receiver is greater than a threshold.

13. The transmitter of claim 12, wherein said admittance is the admittance between two terminals of application, to the generator, of a first excitation signal.

14. The transmitter of claim 13, wherein, when the first excitation signal is applied, said intensity is smaller than said threshold.

15. The transmitter of claim 13, wherein, after the definition of said frequency, a second excitation signal having a peak voltage greater than a peak voltage of the first signal is applied to the generator.

16. The transmitter of claim 11, wherein an acoustic communication frequency band is centered on said frequency.

17. The transmitter of claim 11, wherein said frequency is defined so that the phase of said admittance is substantially extremal for said frequency.

18. An acoustic receiver intended to be secured on one side of a wall and configured to receive an acoustic transmission signal having a frequency defined according to the admittance of an acoustic generator, the acoustic transmission signal being transmitted by a transmitter secured on another side of the wall and comprising the generator.

19. A system comprising an acoustic transmitter comprising an acoustic generator intended to be secured on one side of a wall, configured to define a frequency of an acoustic transmission signal according to the admittance of the generator, the acoustic transmission signal being intended to be received bay an acoustic receiver secure on another side of the wall and the receiver of claim 18.

20. The system of claim 19, further comprising said wall, the generator and the receiver being secured to the wall on either side of the wall.
